(19) United States
(12) Patent Application Publication
(10) Pub. No.: US 2021/0090014 A1
(43) Pub. Date: Mar. 25, 2021

(54) STOCK MANAGEMENT APPARATUS AND NON-TRANSITORY COMPUTER READABLE MEDIUM

(71) Applicant: TOSHIBA TEC KABUSHIKI KAISHA, Tokyo (JP)

(72) Inventor: SIGEKI NIMIYA, Yokohama Kanagawa (JP)

(21) Appl. No.: 16/924,945

(22) Filed: Jul. 9, 2020

(30) Foreign Application Priority Data
Sep. 24, 2019 (JP) 2019-173480

(51) Int. Cl. G06Q 10/08

(52) U.S. Cl. CPC G06Q 10/087

(57) ABSTRACT

According to one or more embodiments, a stock management apparatus comprises a processor configured to acquire stock status information of commodities at a plurality of stores. The processor then identifies whether there is a specific commodity that is excess stock based on the acquired stock status information. First information that identifies the specific commodity in excess stock at a first store of the plurality of stores is then output with second information about the stock status of the specific commodity at another store in the plurality of stores.

### CROSS-REFERENCE TO RELATED APPLICATION

This application is based upon and claims the benefit of priority from Japanese Patent Application No. 2019-173480, filed Sep. 24, 2019, the entire contents of which are incorporated herein by reference.

### FIELD

Embodiments described herein relate generally to a stock management apparatus and a non-transitory computer readable medium storing a stock management program.

### BACKGROUND

A company that operates multiple stores needs to understand and manage commodity stocks in each store for efficient stock management. There has been proposed a stock management system that integrally manages stocks or inventories of commodities, products, or items for a plurality of stores.

Such a stock management system includes, for example, a server capable of communicating with the stores being managed. The server registers information related to surplus stocks of the commodities held in each store. When a shortage of a commodity occurs at one store among the multiple stores, that store inquires, via the server, whether other stores have any surplus stock. The server replies to the inquiring store and then may send requests to another store or stores with surplus stock to send the commodity to the inquiring store.

This stock management system enables the stores being managed to transfer the surplus stock among the multiple stores. However, such a system generally operates to transfer the surplus stock (s) only if there is a requesting store with an identified commodity shortage. Therefore, such a stock management system is not always efficient at resolving the surplus stock situations. For example, if a store that is not yet presently short of a commodity but still expects to be able to sell additional units of the commodity beyond those in its present stock, the management system will not operate to resolve such a stock situation. Therefore, stores that are being managed by such a stock management system are not efficiently utilized to resolve surplus stock situations among managed stores.

### DESCRIPTION OF THE DRAWINGS

FIG. 1 depicts a system comprising a stock management apparatus according to an embodiment.

FIG. 2 depicts a block diagram of a hardware configuration of a stock management apparatus according to an embodiment.

FIG. 3 depicts aspects of a memory storage structure of a stock management apparatus according to an embodiment.

FIG. 4 depicts a functional block diagram of a control unit in a stock management apparatus according to an embodiment.

FIG. 5 depicts a flow of stock management according to an embodiment.

FIG. 6 is a flowchart of stock quantity management by a control unit according to an embodiment.

FIG. 7 is a flowchart of number-of-retention-days management by a control unit according to an embodiment.

FIG. 8 depicts a display example of a stock quantity threshold setting screen in a stock management apparatus according to an embodiment.

FIG. 9 depicts a display example of a number-of-retention-days threshold setting screen in a stock management apparatus according to an embodiment.

FIG. 10 depicts a display example of a notification destination setting screen in a stock management apparatus according to an embodiment.

FIG. 11 depicts a display example of a notification screen for a surplus stock in a stock management apparatus according to an embodiment.

FIG. 12 depicts a display example of a notification screen for a retained stock in a stock management apparatus according to an embodiment.

FIG. 13 depicts a display example of a notification screen for stock states of other stores in a stock management apparatus according to an embodiment.

### DETAILED DESCRIPTION

According to one or more embodiments, a stock management apparatus comprises a processor configured to: acquire stock status information for commodities at a plurality of stores; determine, then identify, based on the acquired stock status information, whether there is a specific commodity that the is in excess stock (which may be related to either of, or both, the in-stock quantity and inventory age/turnover) at a first store in the plurality; and then output first information that identifies the specific commodity and second information relating to stock status of the specific commodity at a second store of the plurality of stores.

Hereinafter, certain example embodiments of a stock management apparatus will be described with reference to the accompanying drawings.

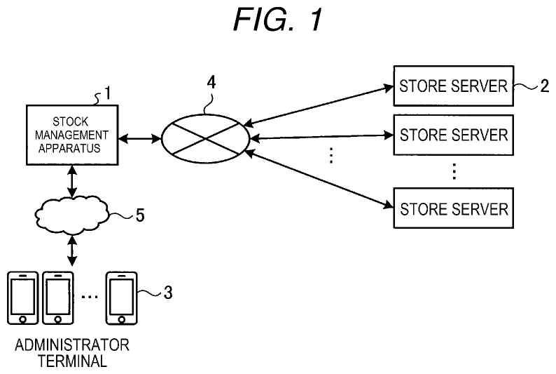

FIG. 1 is a diagram illustrating a stock management system comprising a stock management apparatus 1. This system further comprises a plurality of store servers 2 provided in a plurality of stores and a plurality of administrator terminals 3. The stock management apparatus 1 can be used to understand and manage stock states or inventory levels of the respective stores on a real time basis based on various information acquired from the stores.

The stock management apparatus 1 is connected to the store servers 2 by a network 4, which can be an internal or private communication network using, for example, a leased line or a private line. The store servers 2 manage sales information based on data output from POS (Point Of Sale) terminals in the stores. The store servers 2 also manage stock or inventory information and purchase information in the stores in cooperation with other systems at the respective stores.

The stock management apparatus 1 is connected to the administrator terminals 3 by a network such as a public network 5, such as for example, the internet. The administrator terminals 3 may be personal information terminals such as smartphones carried by store managers of the respective stores or an area manager who manages multiple stores among the plurality of stores. The administrator terminals may also be referred to as store-administrator terminals.

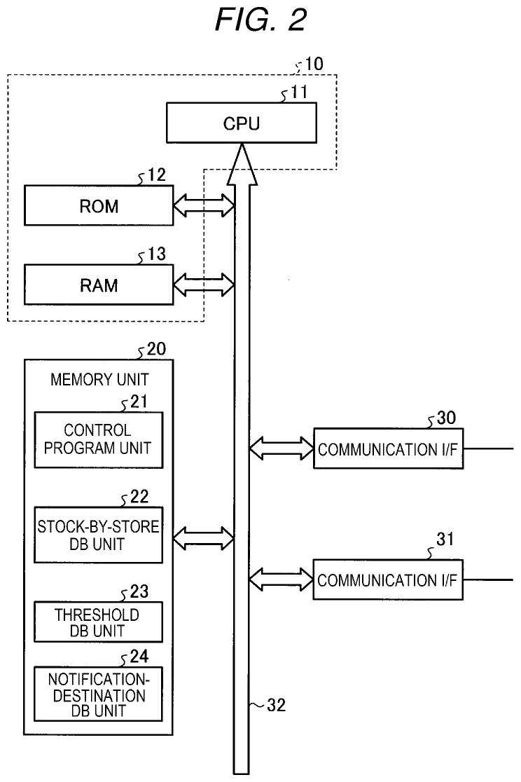

A hardware configuration of the stock management apparatus 1 is described below with reference to FIG. 2. The stock management apparatus 1 includes a control unit 10, a memory unit 20, a communication interface (IF) 30, and a communication interface (IF) 31. The control unit 10, the memory unit 20, the communication I/F 30, and the communication IF 31 are connected to one another via a bus 32.

The control unit 10 includes a CPU (Central Processing Unit) 11, a ROM (Read Only Memory) 12, and a RAM (Random Access Memory) 13. The CPU 11, the ROM 12, and the RAM 13 are connected to one another via the bus 32. The CPU 11 (also referred to as a processor 11 in some contexts) is a control entity of the control unit 10. The ROM 12 stores various programs (or instructions) and data. Various programs and various data stored in the ROM 12 and the memory unit 20 are loaded in the RAM 13 for operation and execution. The CPU 11 operates according to a control program or other various programs stored in the ROM 12 or the memory unit 20 and loaded in the RAM 13, and the control unit 10 executes various kinds of control processing and/or functions of the stock management apparatus 1.

The memory unit 20 includes a control program unit 21, a stock-by-store DB unit 22, a threshold DB unit 23, and a notification-destination DB unit 24. In the following descriptions, references to a “commodity” is not necessarily to be regarded as a reference to an individual, particular instance of a commodity itself but rather a reference to a commodity type being specified by a commodity code.

The control program unit 21 stores various control programs. The stock-by-store DB unit 22 stores a database that holds information relating to stocks of commodities in each store. The threshold DB unit 23 stores a database that holds stock quantity thresholds and number-of-retention-days thresholds set at the respective stores.

The notification-destination DB unit 24 stores a database that holds a notification destination of an administrator who is notified when surplus stock or retained stock occurs.

The communication I/F 30 is connected to the store servers 2 of the stores via the network 4. The communication I/F 31 is connected to the administrator terminals 3 via the public network 5. Consequently, the control unit 10 is capable of transmitting and receiving information to and from the store servers 2 of the stores and the administrator terminals 3 operated by the store administrators.

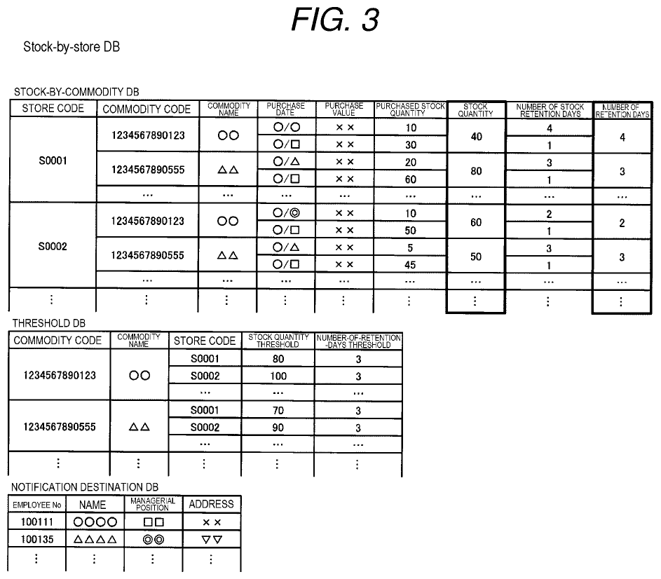

FIG. 3 is a diagram illustrating contents of the stock-by-store DB unit 22, the threshold DB unit 23, and the notification-destination DB unit 24, which are parts of the memory unit 20. The stock-by-store DB unit 22 stores, for each store being managed, a commodity name, a purchase date, a purchase value, a purchased stock quantity, a stock quantity, a number of stock retention days, and a number of retention days in association with a commodity code. The purchase date column shows all purchase dates of commodities that currently remain as stock. The purchase value, the purchased stock quantity, and the number of stock retention days are stored in association with each purchase date. The purchase value is an amount paid when the commodity was purchased and is listed as a price per one commodity.

The purchased stock quantity is the quantity (e.g., number of units) corresponding to each stock purchase date. In the present embodiment, when a commodity is sold in the store, the system assumes that a commodity with an earlier purchase date is sold (e.g., first-in-first-out) and decreases the purchased stock quantity associated with the earliest purchase data in the database. This operation reduces the inventory tracking and management cost. In another embodiment, the system may individually manage each instance of the commodities and determine when and which each particular instance of a commodity has been purchased and then sold to more accurately manage the purchased stock quantity in the database. The stock quantity is a total stock quantity of the commodity type associated with the corresponding commodity code, that is a total of the purchased stock quantities of that commodity. The number of stock retention days indicates the number of days from the purchase date. The number of retention days indicates the highest number of stock retention days for commodities corresponding thereto.

The threshold DB unit 23 stores, for each commodity, a stock quantity threshold and a number-of-retention-days threshold in association with a store code. Both stock quantity threshold and number-of-retention-days threshold are entered in the system at each store. A name, a managerial position, and an address are stored in the notification-destination DB unit 24 in association with an employee number. The managerial position is a managerial position of an administrator in charge of the stock management such as a store manager or an area manager. The address is an email address of the administrator who receives a notification. In the present embodiment, notification destinations are directed to store managers of the respective stores. If surplus stock (that is, the stock exceeding the stock quantity threshold) or retained stock (that is, the stock exceeding the number-of-retention-days threshold) occurs in a store, the existence of surplus stock, or retained stock, is notified to the store manager of that store.

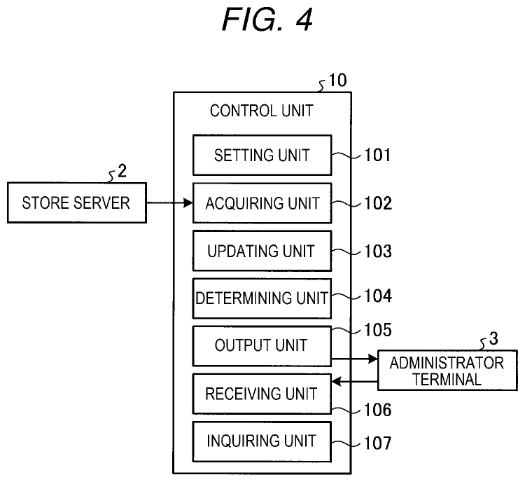

A functional configuration of the control unit 10 will be described below with reference to FIG. 4. The CPU 11 of the control unit 10 (see FIG. 1) executes or operates according to a control program stored in the ROM 12 or the control program unit 21 of the memory unit 20. As shown in FIG. 4, the control unit 10 then functions as a setting unit 101, an acquiring unit 102, an updating unit 103, a determining unit 104, an output unit 105, a receiving unit 106, and an inquiring unit 107.

The control program may be recorded and provided in a computer-readable recording medium such as a CD-ROM. The control program to be executed by the CPU 11 or the control unit 10 of the stock management apparatus 1 according to the present embodiment may be stored on a computer connected to a network such as the Internet and provided to the stock management apparatus 1 by being downloaded via the network. In another embodiment, the control program may be provided or distributed via the network such as the Internet.

The setting unit 101 sets, in the threshold DB unit 23, the stock quantity threshold and the number-of-retention-days threshold that are entered in the store server 2. The setting unit 101 sets, in the notification-destination DB unit 24, a notification destination that is entered in the store server 2. The acquiring unit 102 acquires stock-related information and number-of-retention-days information for each commodity from the store server 2. In one embodiment, the acquiring unit 102 acquires, from the store server 2, once every day, information related to the purchase date, the purchase value, the purchased stock quantity, the stock quantity, the number of stock retention days, and the number of retention days shown in the stock-by-store DB unit 22 as illustrated in FIG. 3.

If the purchase-related information is updated by an order and purchase system of the store, the acquiring unit 102 acquires the purchase-related information from the store server 2 every time the purchase-related information is updated.

Furthermore, the acquiring unit 102 acquires sales information from the store server 2 every time a transaction is performed in the store. Therefore, the stock management apparatus 1 can provide visibility as to the stock quantities of commodities in the multiple stores in a timely manner.

In the present embodiment, the stock-related information and the number-of-retention-days information are the purchase-related information and the sales-related information as shown in the stock-by-store DB unit 22 in FIG. 3. In other embodiments, the stock-related information and the number-of-retention-days information may be any information that the stock management apparatus 1 can use to review or identify the stock quantity and the number of retention days.

If the acquiring unit 102 acquires the various kinds of information from the store server 2, the updating unit 103 performs necessary calculations and the like and updates the stock-by-store DB unit 22.

The determining unit 104 compares the stock quantity stored in the stock-by-store DB unit 22 with the stock quantity threshold stored in the threshold DB unit 23 and determines whether surplus stock has occurred with any commodity in the stores. The determining unit 104 compares the number of retention days stored in the stock-by-store DB unit 22 with the number-of-retention-days threshold stored in the threshold DB unit 23 and determines whether there is a retained stock situation that has occurred with any commodity in the stores.

If any one of the stock quantities of the commodities in at least one of the stores is recognized, based on the stock-related information acquired by the acquiring unit 102, as exceeding the corresponding stock quantity threshold, the output unit 105 outputs information relating to the specific commodity with stock quantity exceeding the stock quantity threshold and stock information relating to the specific commodity in another store different from the store where the stock quantity has exceeded the stock quantity threshold.

If any one of number of the retention days of the commodities in at least one of the stores is recognized, based on the number-of-retention-days information acquired by the acquiring unit 102, as exceeding the corresponding number-of-retention-days threshold, the output unit 105 outputs information relating to the specific commodity having the number of retention days exceeding the number-of-retention-days threshold and stock information relating to the specific commodity in another store different from the store where the number of retention days has exceeded the number-of-retention-days threshold.

According to an embodiment, if the determining unit 104 determines whether there is any surplus stock or retained stock has occurred (that is, whether either one or both has occurred, hereinafter referred to as “excess stock”), the output unit 105 outputs information such as first and/or second information as explained in the following. In this context, “first information” is information relating to the specific commodity with the excess stock, such as a commodity name and a stock quantity, and “second information” is stock information relating to the specific commodity, such as a stock quantity and a purchase value, in another store different from the store where the excess stock has occurred.

The output unit 105 outputs the information to an administrator designated for the store with the excess stock from among administrators stored in the notification destination DB unit 24. In this embodiment, the designated administrator is a store manager of the store with the excess stock.

The receiving unit 106 receives an inquiry about delivery of the excess stock of the specific commodity. Specifically, the receiving unit 106 receives an inquiry from the administrator terminal 3 that received a notification of excess stock, about whether the excess stock can be transferred to another store. The inquiring unit 107 may then send inquires to the relevant store(s) regarding the inquiries received by the receiving unit 106.

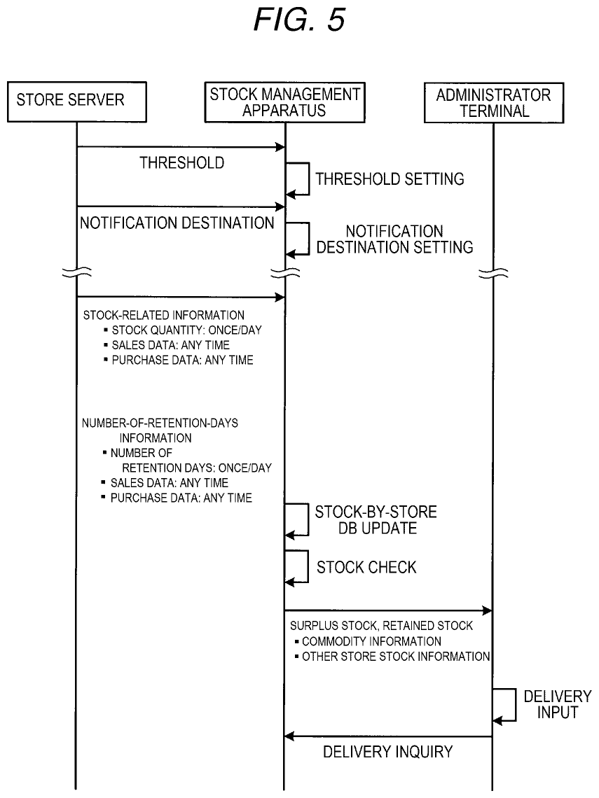

A flow of the stock management by the system will be described below with reference to a sequence chart of FIG. 5 according to an embodiment. First, the store server 2 transmits a stock quantity threshold and a number-of-retention-days threshold to the stock management apparatus 1. The stock management apparatus 1 stores the received stock quantity threshold and the received number-of-retention-days threshold in the threshold DB unit 23.

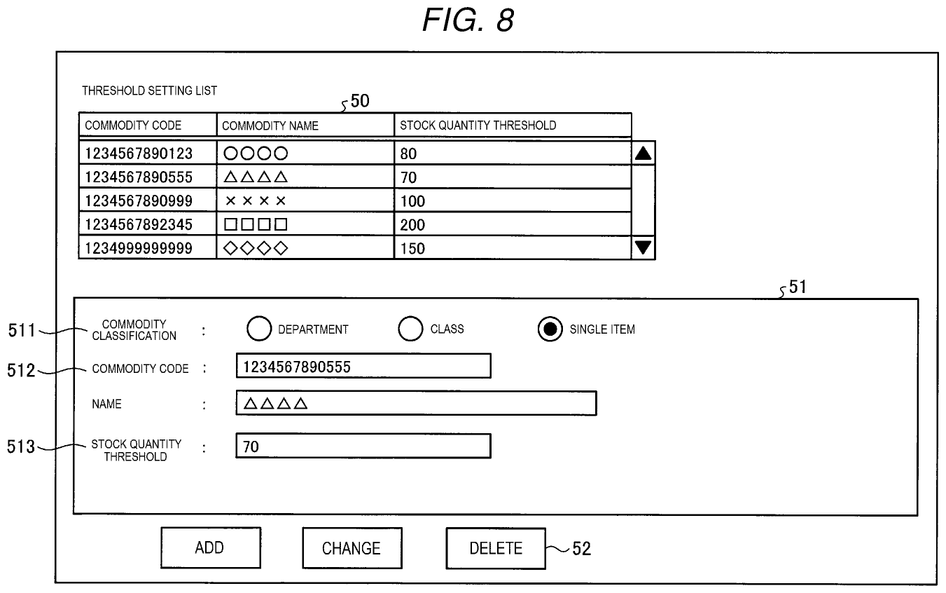

FIG. 8 illustrates one example of an input screen for a stock quantity threshold. The input screen includes a confirmation section 50, an input section 51, and an instruction section 52. The confirmation section 50 is a screen on which input content is displayed and an inputter confirms the content. The input section 51 is a screen for inputting a stock quantity threshold for a commodity.

Items input by a user are a commodity classification 511, a commodity code 512, and a stock quantity threshold 513. If a specific commodity code is entered as the commodity code 512, a commodity name corresponding to the entered commodity code is displayed in the name section on the input screen. The commodity classification 511 designates hierarchical categorization levels of each commodity. For example, in the respective hierarchical levels: a single item level designates the tea (an item) is produced by a manufacturer AA, has content (size) of BB milliliters, and is stored in a PET bottle; a class level designates that the tea (item) is produced by manufacturer AA and stored in a PET bottle; and a department level designates the tea is manufactured by manufacturer AA.

If a user designates the class on the screen illustrated in FIG. 8 and enters a commodity code and a stock quantity threshold, the user can set values for all commodities that belong to the designated class, in which the specific commodity corresponding to the entered commodity code is included, to the entered stock quantity threshold value.

The stock management apparatus 1 in this embodiment is thus capable of collectively setting the stock quantity thresholds with respect each item in the designated hierarchical level(s).

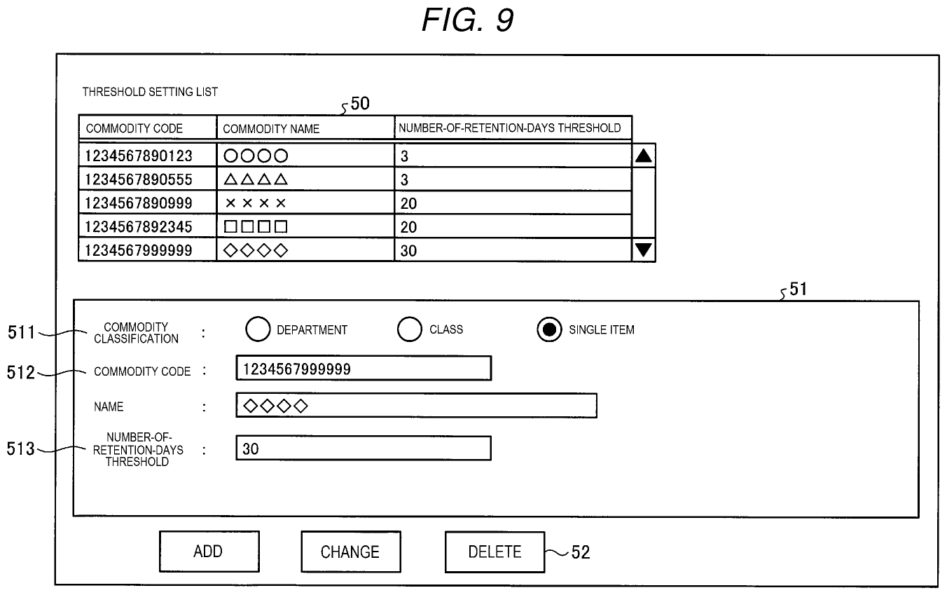

The instruction section 52 is a screen for instructing addition, change, and deletion of the contents in the input section 51. FIG. 9 is one example of an input screen for a number-of-retention-days threshold. In the input screen, the number-of-retention-days thresholds are entered for the respective commodities.

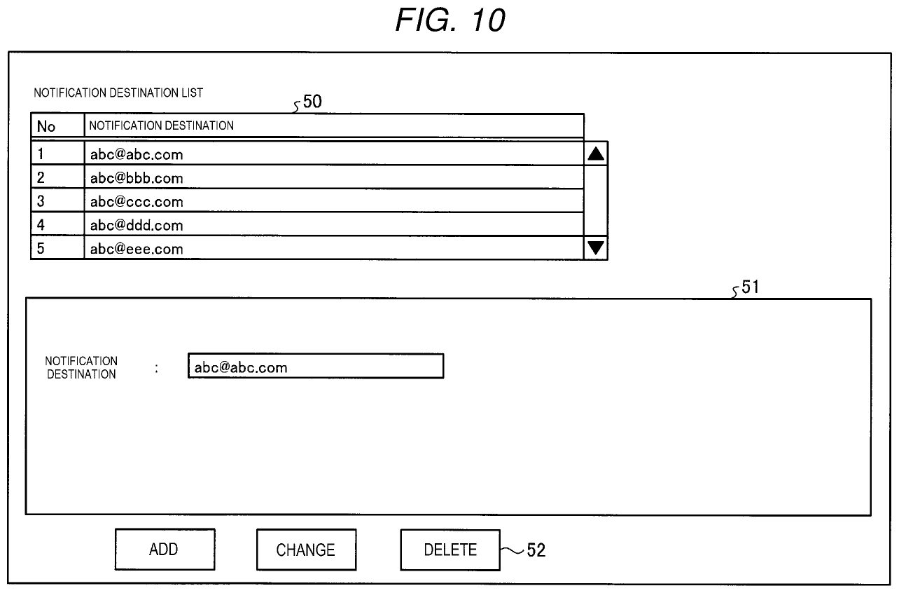

Referring back to FIG. 5, the store server 2 transmits the input notification destination to the stock management apparatus 1. The stock management apparatus 1 sets the received notification destination in the notification-destination DB unit 24. FIG. 10 is one example of an input screen for a notification destination. In this input screen, an email address to be used for a notification is entered in the input section 51, and the entered address is displayed in the confirmation section 50. In the example illustrated in FIG. 10, email addresses are set for the respective administrators to whom a notification will be sent such as an area manager and a store-related person.

At a specific time, such as the end of the store business hours every day, the store server 2 transmits the information including the purchase date, the purchase value, the purchased stock quantity, the stock quantity, the number of stock retention days, and the number of retention days of the commodities as shown in the stock-by-store DB unit 22 of FIG. 3 to the stock management apparatus 1. The store server 2 also transmits, every time a transaction is performed in the store, the sales information including the number of commodities sold in the transaction to the stock management apparatus 1. Further, the store server 2 transmits, every time purchase is performed by the store, the purchase information including a purchase date, a purchase value, and the number of purchases to the stock management apparatus 1. The stock management apparatus 1 updates the stock-by-store DB unit 22 based on the received information.

The stock management apparatus 1 performs a stock check every time the stock-by-store DB unit 22 is updated. During the stock check, the stock management apparatus 1 determines whether there is any excess stock, that is whether there is any surplus stock or any retained stock.

In one embodiment, for the surplus stock check, the stock management apparatus 1 may determine whether a stock quantity of any commodity in the stores in the updated stock-by-store DB unit 22 exceeds the stock quantity threshold stored in the threshold DB unit 23.

For the retained stock check, the stock management apparatus 1 may determine whether the number of retention days of any commodity in the stores in the updated stock-by-store DB unit 22 exceeds the number-of-retention-days threshold stored in the threshold DB unit 23.

If the excess stock occurs in a store, the stock management apparatus 1 transmits information to the registered administrator of the store with the excess stock. The information to be transmitted includes a commodity name and a stock quantity of the specific commodity with the excess stock as well as a stock quantity of the specific commodity in another store or stores near the first store. Other information or data may also be transmitted together with this information.

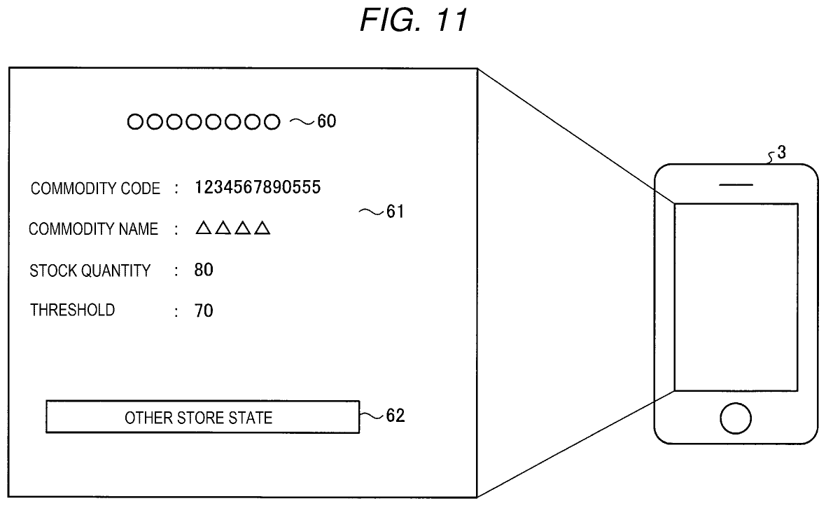

FIG. 11 is an example of a screen of the administrator terminal 3 that has received a notification of surplus stock. The screen includes a message section 60, a commodity notification section 61, and another store confirmation section 62 (also referred to as a status confirmation section for other stores). A message such as “stock of the following commodity is in surplus” is displayed in the message section 60. Information identifying the commodity in stock surplus is displayed in the commodity notification section 61.

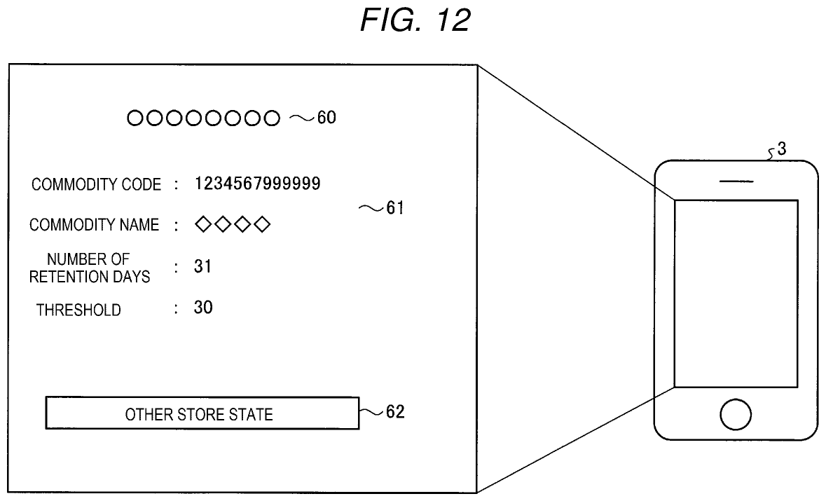

In this embodiment, the commodity notification section 61 displays a commodity code, a commodity name, a stock quantity, and a stock quantity threshold. FIG. 12 is an example of a screen of the administrator terminal 3 that has received a notification of retained stock. The screen as illustrated in FIG. 12 displays a message such as “retained stock” in the message section 60. The number of retention days and the number-of-retention-days threshold are displayed in the commodity notifying section 61.

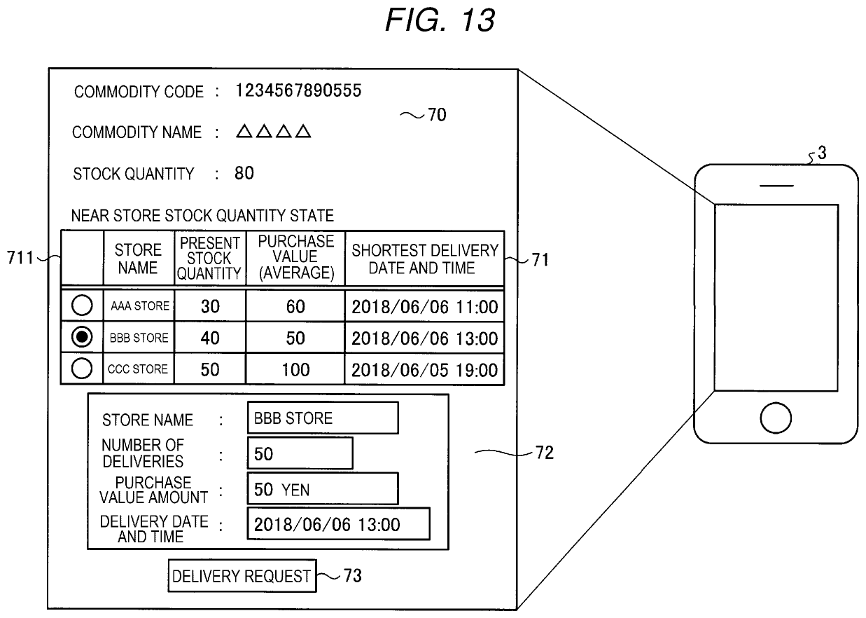

In the example of FIGS. 11 and 12, the other store confirmation section 62 is an operation button. If this button is pressed or operated by the administrator at the first store who carries the administrator terminal 3 receiving the notification, the administrator terminal 3 switches screens to show the stock information of the specific commodity in neighboring stores (or second stores) of the first store as illustrated in FIG. 13.

In the example of FIG. 13, the commodity information section 70 displays the information such as a commodity code, a commodity name, and a stock quantity of the specific commodity. The same screen can be displayed for both the surplus stock event screen (shown in FIG. 11) and the retained stock event screen (shown in FIG. 12). The stock quantity indicated in the commodity information section 70 is the stock quantity at the time when surplus stock or retained stock event occurs.

The store information unit 71 displays the stock information of the specific commodity in the neighboring stores. In this embodiment, the stock information includes a name of each second store, a current stock quantity at each second store, a purchase value (or an average purchase value) at the time when the second store purchased the stock commodity, and a soonest delivery date and time for delivery of the excess stock from the first store to the neighboring store. The displayed stock information is information for an administrator to determine to which neighboring store the excess stock should be delivered. The displayed stock information thus includes at least information for identifying the neighboring store and the present stock quantity of the specific commodity at the neighboring store. The store information unit 71 further includes a selection section 711 for selecting one of the displayed neighboring stores.

Referring back to FIG. 5, the administrator terminal 3, which has received the notification of the excess stock, can accept a delivery request (delivery input). The delivery input is performed by operating a delivery request section 73 illustrated in FIG. 13. Upon the delivery input, the administrator terminal 3 sends a delivery inquiry to the stock management apparatus 1. The stock management apparatus 1 then sends an inquiry to the selected store (from among the listed second stores) asking whether the selected store can receive the excess stock commodity. If the selected second store can receive the excess stock commodity, the stock management apparatus 1 starts to perform delivery processing. If the selected second store cannot receive the excess stock commodity, the stock management apparatus 1 notifies the inquiring administrator terminal 3 that the excess stock commodity cannot be delivered to the selected second store.

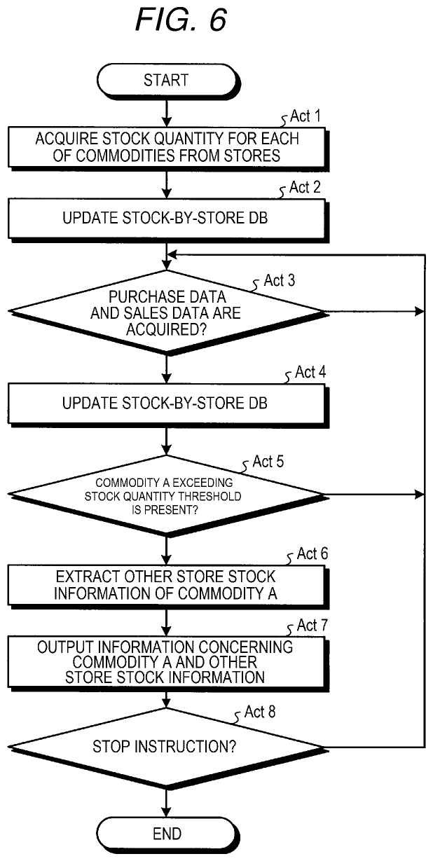

Processing of the stock quantity management performed by the control unit 10 of the stock management apparatus 1 is described with reference to the flowchart of FIG. 6.

First, the acquiring unit 102 acquires information such as the stock quantity of each commodity from each store once a day (Act 1). The updating unit 103 updates the stock-by-store DB unit 22 based on the acquired information (Act 2). Subsequently, the control unit 10 determines whether the acquiring unit 102 has acquired the purchase information and the sales information (Act 3). If the acquiring unit 102 has acquired such information, the updating unit 103 updates the stock-by-store DB unit 22 (Act 4). If the acquiring unit 102 has not received the information in Act 3, the control unit 10 returns to Act 3 and stays on standby.

If the updating unit 103 updates the stock-by-store DB unit 22 in Act 4, the determining unit 104 determines whether there is a commodity that exceeds the stock quantity threshold (hereinafter referred to as Commodity A) (Act 5). If there exists such a Commodity A, the control unit 10 extracts the stock information of Commodity A at the second stores (such as predetermined neighboring stores of the first store) from the stock-by-store DB unit 22 (Act 6). If a Commodity A is not found in Act 5, the control unit 10 returns to Act 3. After Act 6, the output unit 105 outputs information of Commodity A and stock information of Commodity A of the second stores (Act 7). Subsequently, the control unit 10 determines whether a stop instruction for the stock quantity management processing is received (Act 8). If the stop instruction is received, the control unit 10 ends the stock quantity management processing. If the stop instruction is not received in Act 8, the control unit 10 returns to Act 3.

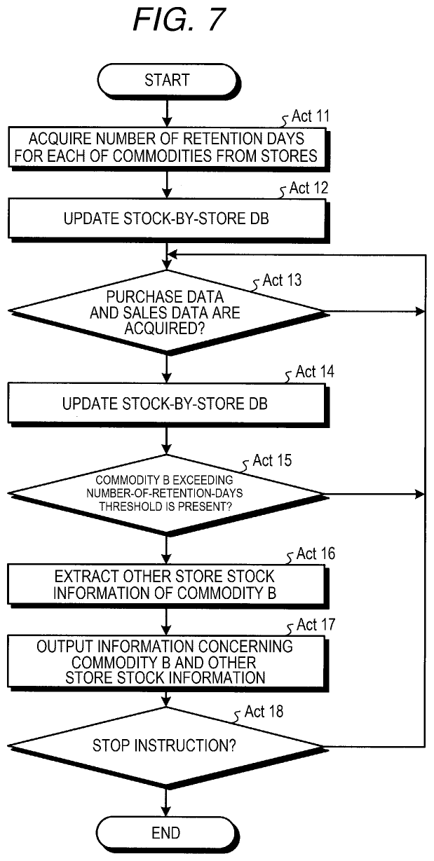

Processing of the number-of-retention-days management performed by the control unit 10 of the stock management apparatus 1 will be described below with reference to the flowchart of FIG. 7.

First, the acquiring unit 102 acquires information related to the number of retention days for each commodity from each store once a day (Act 11). The updating unit 103 updates the stock-by-store DB unit 22 based on the acquired information (Act 12). Subsequently, the control unit 10 determines whether the acquiring unit 102 has acquired purchase information and sales information (Act 13). If the acquiring unit 102 has acquired such information, the updating unit 103 updates the stock-by-store DB unit 22 (Act 14). If the acquiring unit 102 has not acquired the information in Act 13, the control unit 10 returns to Act 13 and stays on standby.

If the updating unit 103 updates the stock-by-store DB unit 22 in Act 14, the determining unit 104 determines whether there is a commodity that exceeds the number-of-retention-days threshold (hereinafter referred to as Commodity B) (Act 15). If there exists such a Commodity B, the control unit 10 extracts the stock information of the Commodity B from the second stores from the stock-by-store DB unit 22 (Act 16). If a Commodity B is not found in Act 15, the control unit 10 returns to Act 13. After Act 16, the output unit 105 outputs the commodity information of the Commodity B and the stock information of the Commodity B at the second stores to the administrator terminal 3 (Act 17). Subsequently, the control unit 10 determines whether a stop instruction for the stock quantity management processing is received (Act 18). If the stop instruction is received, the control unit 10 ends the stock quantity management processing. If the stop instruction is not received in Act 18, the control unit 10 returns to Act 13.

As described above, with the stock management apparatus according to the present embodiment, if excess stock occurs with a specific commodity at a first store among a plurality of stores, information relating to the specific commodity in excess stock and information about the stock of the specific commodity at other stores (second stores) are output to the administrator terminal 3. The administrator carrying the administrator terminal 3 can then decide to select another store that is potentially capable of receiving the specific commodity and arrange the delivery of the specific commodity that is in excess or surplus at the first store to the selected other store. Therefore, an entity such as a company that operates multiple stores can efficiently resolve excess stocks by effectively identifying other stores, such as other nearby stores, that can accept the excess stock from the first store even when the specific commodity is not presently identified as being in short supply at such second stores.

Further, the stock management apparatus according to the present embodiment comprises a receiving unit that receives an inquiry to be directed to the other stores about the possible delivery of the excess stock from a first store. This achieves an efficient and swift procedure of confirming whether there are any near-by stores capable of receiving the excess stock. As a result, it is possible to quickly resolve the excess stock situation.

In this embodiment, if excess stock occurs at a first store, the administrator terminal 3 switches the screen that shows the information relating to or identifying the specific commodity in excess stock, as illustrated in FIGS. 11 and 12, to a screen (as illustrated in FIG. 13) that shows the stock information relating to the specific commodity at the second stores.

In other embodiments, the administrator terminal 3 may display the information relating to the specific commodity in excess stock at the first store and the stock information relating to the specific commodity in the second stores on the same screen. In general, the methods, formats, and the like of displaying such information may be set at the administrator terminal 3 as desired by a user, such as a store administrator, or a manager of each store or a company that utilizes the stock management apparatus and system.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stock management apparatus, comprising:
a processor configured to:
acquire stock status information for commodities at a plurality of stores;
identify a specific commodity in excess stock at a first store in the plurality of stores based on the acquired stock status information; and
output first information identifying the specific commodity as being in excess stock at the first store and second information about stock status of the specific commodity at a second store in the plurality of stores.

2. The stock management apparatus according to claim 1, wherein the processor is further configured to:
acquire a stock quantity for each of the commodities from a plurality of store servers; and
determine whether the stock quantity of each commodity exceeds a stock quantity threshold for the commodity.

3. The stock management apparatus according to claim 2, wherein each stock quantity threshold is predetermined for each of the plurality of stores.

4. The stock management apparatus according to claim 1, wherein the processor is further configured to:
acquire a number of retention days of each of the commodities from a plurality of store servers; and
determine whether the number of retention days of each commodity exceeds a number-of-retention-days threshold for the commodity.

5. The stock management apparatus according to claim 4, wherein each number-of-retention-days threshold is predetermined for each of the plurality of stores.

6. The stock management apparatus according to claim 1, wherein the processor is further configured to receive an inquiry about whether a second store in the plurality of stores will accept a transfer of the specific commodity from the first store.

7. The stock management apparatus according to claim 6, wherein the processor is further configured to receive an acknowledgement from the second store accepting the transfer of the specific commodity.

8. The stock management apparatus according to claim 7, wherein the processor is further configured to receive a request from the first store to deliver the specific commodity to the second store.

9. The stock management apparatus according to claim 1, further comprising a database configured to hold the first and the second information.

10. The stock management apparatus according to claim 1, wherein the processor is further configured to send the first and second information to a plurality of store-administrator terminals.

11. A non-transitory computer readable medium storing a program which when executed causes a computer to perform a process for commodity stock management, the process comprising:
acquiring stock status information for commodities at a plurality of stores;
identifying a specific commodity in excess stock at a first store in the plurality of stores based on the acquired stock status information; and
outputting first information identifying the specific commodity as being in excess stock at the first store and second information about stock status of the specific commodity at a second store in the plurality of stores.

12. The non-transitory computer readable medium according to claim 11, wherein the process further comprises:
acquiring a stock quantity for each of the commodities from a plurality of store servers; and
determining whether the stock quantity of each commodity exceeds a stock quantity threshold for the commodity.

13. The non-transitory computer readable medium according to claim 11, wherein the process further comprises:
acquiring a number of retention days of each of the commodities from a plurality of store servers; and
determining whether the number of retention days of each commodity exceeds a number-of-retention-days threshold for the commodity.

14. The non-transitory computer readable medium according to claim 11, wherein the process further comprises receiving an inquiry about whether a second store in the plurality of stores will accept a transfer of the specific commodity from the first store.

15. The non-transitory computer readable medium according to claim 11, wherein the process further comprises receiving an acknowledgement from the second store accepting the transfer of the specific commodity.

16. The non-transitory computer readable medium according to claim 11, wherein the process further comprises receiving a request from the first store to deliver the specific commodity to the second store.

17. A stock management system, comprising:
a stock management apparatus including a processor;
a plurality of store servers for a plurality of stores communicatively coupled to the stock management apparatus via a network; and
a plurality of store-administrator terminals configured to receive notifications from the stock management apparatus, wherein
the processor is configured to:
acquire stock status information for commodities at the plurality of stores from the plurality of store servers;
identify a specific commodity in excess stock at a first store in the plurality of stores based on the acquired stock status information; and
output, to a first store-administrator terminal in the plurality of store-administrator terminals, first information identifying the specific commodity as being in excess stock at the first store and second information about stock status of the specific commodity at a second store in the plurality of stores.

18. The stock management system according to claim 17, wherein the processor is further configured to:
acquire a stock quantity of each of the commodities from the plurality of store servers; and
determine whether the stock quantity of each commodity exceeds a stock quantity threshold for the commodity.

19. The stock management apparatus according to claim 17, wherein the processor is further configured to:
acquire a number of retention days of each of the commodities from the plurality of store servers; and
determine whether the number of retention days of each commodity exceeds a number-of-retention-days threshold for the commodity.

20. The stock management apparatus according to claim 17, wherein the processor is further configured to:
receive an inquiry from the first store-administrator terminal about whether to the second store will accept a transfer of the specific commodity from the first store.
